(19) United States
(12) Patent Application Publication
(10) Pub. No.: US 2001/0042797 A1
(43) Pub. Date: Nov. 22, 2001

(54) Water wand

(76) Inventor: Ross P. Shrigley, Ft. Collins, CO (US)

Correspondence Address: Dean P. Edmundson, P. O. Box 710, Windsor, CO, 80550, US

(21) Appl. No.: 09/880,662

(22) Filed: Jun. 13, 2001

Related U.S. Application Data
(63) Continuation-in-part of application No. 09/465,051, filed on Dec. 16, 1999.
(60) Provisional application No. 60/114,560, filed on Dec. 31, 1998.

(51) Int. Cl. B05B 1/14

(52) U.S. Cl. 239/548; 239/532

(57) ABSTRACT

A hand-held, portable dispensing device (i.e. a wand) is described for dispensing a curtain spray pattern of liquid which includes an elongated tubular body having an open end and a closed end. The open end can be connected to a flexible hose or the like for supplying pressurized liquid to the tubular body which has a plurality of spaced openings along its length on one side. The spacing of the discharge openings is determined by the diameter of the openings, and the ratio of the total area of the openings to the inside diameter of the tubular body is in a defined range. The openings can be in a single line or in a plurality of rows, for example, An adjustable control valve and a quick connect coupler can also be included.

### CROSS-REFERENCE TO RELATED APPLICATIONS

This application is a continuation-in-part of my earlier application Ser. No. 09/465,051, filed Dec. 16, 1999, which claimed the benefit of my Provisional Application No. 60/114,560, filed Dec. 31, 1998.

### FIELD OF THE INVENTION

This invention relates to fluid dispensing devices. More particularly, this invention relates to devices for dispensing liquids such as water, etc.

### BACKGROUND OF THE INVENTION

A variety of devices has been used for dispensing pressurized fluids such as water from a flexible hose. For example, a spray nozzle is commonly attached to the end of the hose. Spray nozzles typically include a pistol grip and a movable trigger which controls the flow rate of water through the nozzle. The nozzle style and design determine the spray pattern of water exiting the nozzle. See, for example, U.S. Pat. No. 5,598,978. Spray wands have also been described, e.g. in U.S. Pat. Nos. 4,982,896 and 5,419,496. Another type of plant watering device is described in U.S. Pat. No. 4,097,020. Other patents for dispensing fluids include U.S. Pat. Nos. 2,854,150, 6,079,640, 5,335,855, 5,964,419, 4,919,336, 1,440,896 and 4,600,153.

Circle spray patterns and misting spray nozzles, as part of hand held tools, are currently the only means of hand watering plants in flats or on benches. Neither of these spray patterns dispenses an even coverage of water across their spray pattern. Delivering an even coverage of water over plants is important to the aesthetics and marketability of those plants. Plants grown evenly in a flat (e.g. flowers) are a more desirable product because the evenness and uniformity of the plant shows that they are all healthy and equally cared for. To grow plants evenly, they must be watered evenly. Current hand-held sprayers do not offer an even coverage of water. Therefore, a grower must constantly be spot watering benches of flats where less water has been delivered and soil has dried out sooner than on the rest of the bench. Those underwatered areas are usually only a few cells of each flat.

The devices which have been previously used for dispensing water have not provided a curtain pattern of water. Consequently, such previous devices are not suitable for dispensing water accurately to a seed tray or plant bed, for example.

### SUMMARY OF THE INVENTION

In accordance with the present invention there is provided a unique water wand which can be attached to the end of a flexible hose and is useful for dispensing a very uniform and gentle pattern of water or other fluid. The hand-held wand comprises an elongated tubular body having an open end and a closed end (preferably closed with a removable cap member). The open end is adapted to be connected to a flexible hose for supplying pressurized water or other fluid to the wand. The wand includes a plurality of openings spaced along and extending through the wall on one side of the wand to enable water to exit the wand in a very uniform pattern.

The wand of this invention is portable and can be used in a variety of situations—wherever a uniform curtain of water or other fluid is desired. It is especially useful for watering seed trays or plant beds where it is necessary or desirable to apply a very uniform amount of water or other fluid to the bed in a gentle manner.

Having a spray pattern of holes that run in a line down the length (or a portion of the length) of an elongated tube makes this water wand more gentle because, as the wand is waved over delicate plants such as seedlings or annuals, the water only covers a fraction of the plant at one time. This gives the plant enough time to rebound and repel the water into the soil without accumulating so much water on the plant at once that the water weighs the leaflets and flower heads down, causing them to become stuck in the soil. This gentleness also makes the device of the invention ideal for use in watering seedling flats or gardens or grass seed on a slope because the water hitting the soil at any given point is able to soak into the soil gently rather than just erode the soil away.

Another advantage with a spray pattern of holes that run in a single line or multiple lines next to each other is that it greatly facilitates even coverage watering. A common problem with watering a flat of flowers or a flower bed is that it is difficult to know how much watering has been done on it without probing through the soil in several areas. Current shower head or circular hole pattern spray heads disperse the water in such a way that it makes it difficult to evenly water a large area or to water only a square flat of flowers because one must water off the edge of the flat in an attempt to achieve even coverage. However, using the water wand of the invention, a water curtain is simply waved over a flat of flowers or a flower bed, and the operator knows that as much water has fallen on the area that is farthest away from him as has fallen closest to him, and the amount of water he would like to apply in a certain area is simply executed by how many times he has passed the rain curtain over the desired area.

Yet another advantage with a spray pattern of holes that run in a single line or multiple lines next to each other is that it greatly facilitates accuracy of watering. In the nursery business, multiple flats of plants are grouped together on tables. Different plants have different water requirements, and the cells around the edge of the flats always dry out before those in the center of the flat. The accuracy required to water just those plants on the edge of the flat or to water only a single flat evenly, without watering the ones that surround it, is important in the industry and cannot be achieved with previous hand held spray heads.

In the case of watering gallon size pots, the existing shower head watering devices distribute a significantly higher volume of water around the outer edges of the circular pattern than in the center, because of the fluid dynamics that exist within the head. This creates an accuracy problem when several pots are stored next to each other and only one needs to be watered. When an operator holds the shower head wand farther than six inches above the plant, most of the water dispensed goes into the surrounding pots, thereby creating excess water for the surrounding plants just to achieve the desired amount in the pot which requires watering. Increasing accuracy by taking off the spray head results in the soil being washed out and the roots of the plant exposed.

Other features and advantages of the wand of this invention will be apparent from the following detailed description and the accompanying drawings.

### BRIEF DESCRIPTION OF THE DRAWINGS

The invention is described in more detail hereafter with reference to the accompanying drawings, wherein like reference characters refer to the same parts throughout the several views and in which:

FIG. 1 is an exploded view of a preferred embodiment of a watering wand of the invention;

FIG. 1A is an enlarged view of one end of the wand of FIG. 1;

FIG. 1B is a cross-sectional view of the tube of FIG. 1A taken along line B-B;

FIGS. 2-4 are side elevational views of three different embodiments of wands of the invention;

FIGS. 5, 6, 7 and 8 are side elevational views of different embodiments of elongated tubes which are useful in the wands of the invention;

FIGS. 9 and 10 are bottom views of two different embodiments of elongated tubes which are useful in the wands;

FIG. 11 is a side elevational view of another embodiment of tube which is useful herein;

FIG. 12 is a side elevational view of one embodiment of an elongated sleeve which is useful in combination with the tube of FIG. 11;

FIG. 13 is a cross-sectional view of a watering wand comprising the tube of FIG. 11 and the sleeve of FIG. 12.

### DETAILED DESCRIPTION OF THE INVENTION

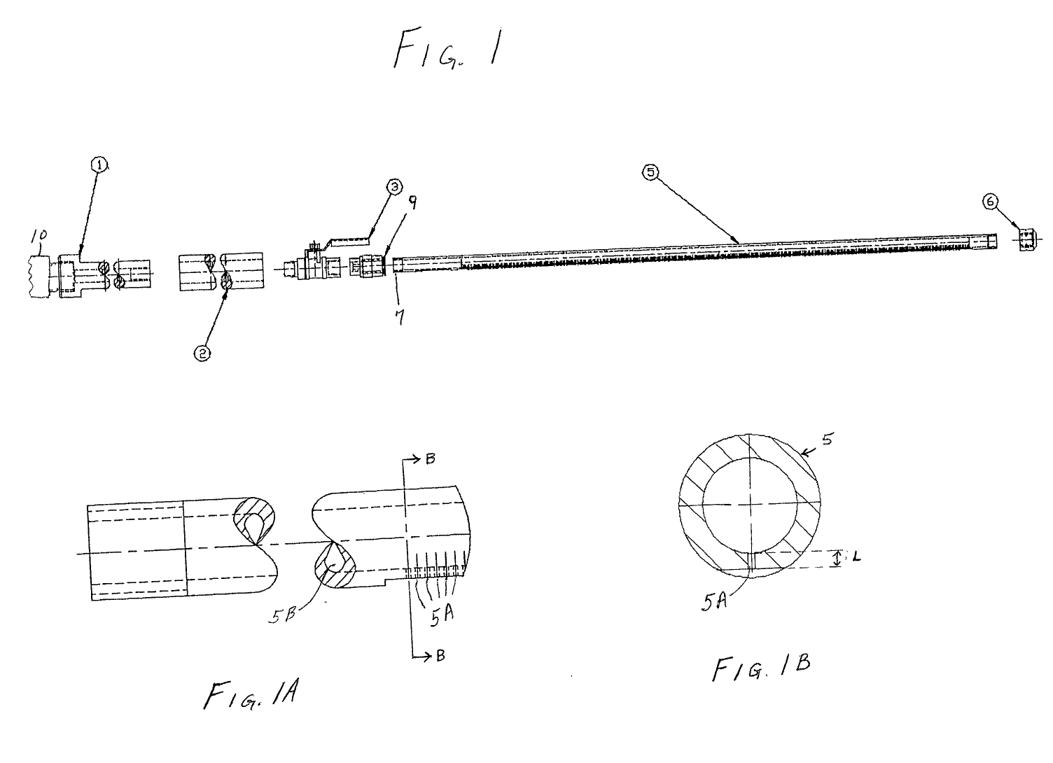

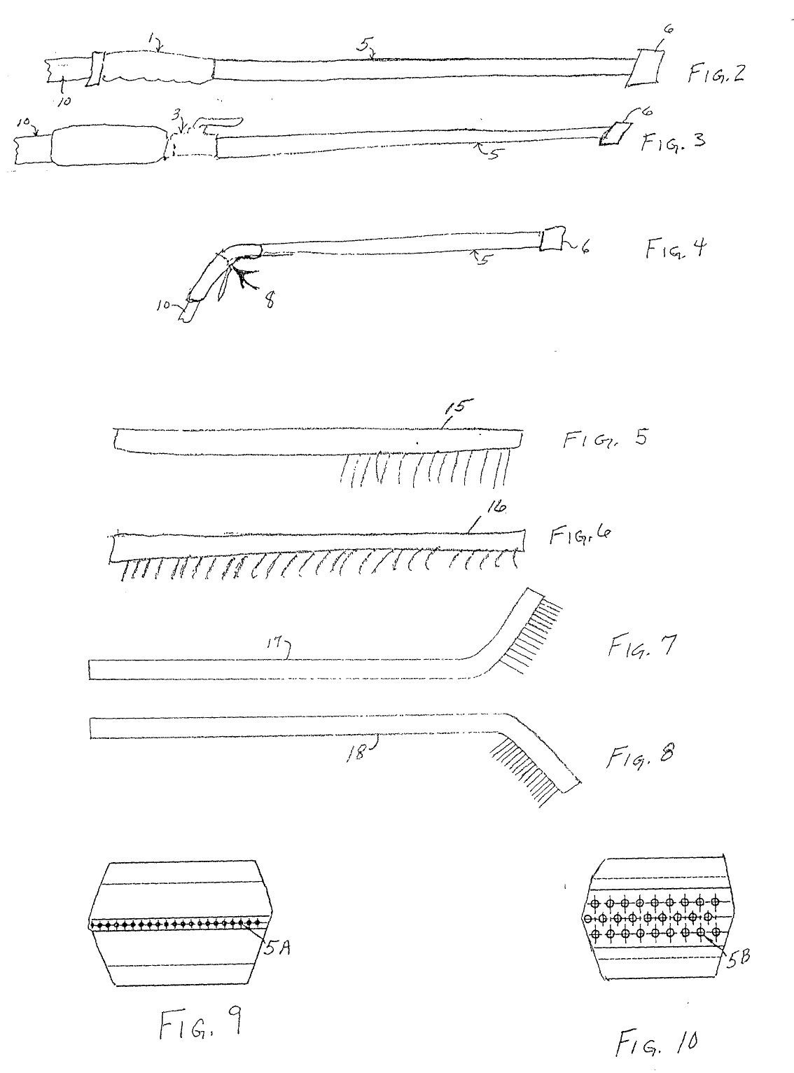

In FIGS. 1 and 1A there is shown one embodiment of a watering wand which includes an elongated tubular body 5 having an open end 7 and an opposite end which is closed by means of removable cap 6. The tubular body includes a plurality of openings 5A extending through a side wall of the tubular body so as to communicate with the interior passageway 5B of the tubular body. By having the removable cap 6 on the outer end of the wand, general maintenance of the wand is greatly facilitated. Dirt and debris can get into hoses which can clog the holes of the wand. By simply removing the cap 6, any dirt or debris can be flushed out through the outer end of the wand. When holes are clogged in any watering apparatus, water is deflected, and this results in a disruption of any intended accuracy or attempt at even coverage. Also, any debris caught in the holes can be simply pushed through and into the interior of the wand where it can be flushed out the end. The device of this invention thus facilitates cleaning and lets the wand provide even coverage consistently. This ease of maintenance is important in the nursery business.

Preferably, a flow control valve 3 is connected to the open end of the tubular body to control the flow rate of fluid through the tube. The type of valve may vary.

The valve is connected to a handle portion 1, and a rubber grip member 2 may surround the handle. The handle includes an interior passageway allowing fluid from a hose 10 to which it is connected to flow through to the valve. If desired, a filter or diffuser may be included between the valve and the open end of the tubular body. It is also preferable to include a quick-connect coupler 9 between the control valve 3 and the open end of the tubular body 5 to enable the user to readily and easily disconnect a particular tubular body and install a different tubular body (e.g. of a different length or with a different hole pattern). The coupler 9 is a hollow body with a sliding collar which, in a first position enables the end of a tubular body to be released, and in a second position it prevents the end of the tubular body from separating from the coupler. These types of quick-connect couplers are known and are commonly used, for example, in air hose connections to enable a desired type of air tool to be readily and easily attached (or detached) from the end of an air hose. Optionally, a quick-connect coupler could be used at the outer end of a first tube to connect a second tube which can then be rotated or swiveled relative to the first tube. Such an arrangement is useful when the first tube (i.e. which is connected to the handle of the device) is curved and the second tube is straight, e.g. for watering plants in hanging baskets or pots.

The tubular body may vary in length (e.g. up to about 45 inches). It may also vary in inside diameter (e.g. from 0.25 to 1.5 inches). The tubular body may be composed of any suitable self-supporting material such as metal, plastic, or composite materials.

Preferably the tubular body is straight, as illustrated in FIGS. 1-6, although it is possible for the body to include a curved section, e.g. as shown in FIGS. 7 and 8, if desired.

FIG. 1B is a cross-sectional view of the tubular body of FIGS. 1 and 1A taken along line B-B in FIG. 1A. This figure shows one of the discharge openings 5A in the wall of the tubular body. The length L of the discharge opening 5A is equal to wall thickness of the tubular body at that point. A preferred range for L is 0.5 to 3 times the diameter of opening 5A.

For the purposes of this invention it has been found that there is criticality to the ratio of the total area of the discharge openings to the area of the inside diameter of the tubular body 5. That is, the ratio of (1) the area of all the discharge openings added together, divided by (2) the area of the inside diameter of the tubular body, must be in the range of 0.03 to 5 in order for the water to be properly discharged as a curtain from the openings in the tubular body.

FIG. 2 shows another embodiment of a wand of the invention which does not include a valve. The embodiment shown in FIG. 3 has a ball valve next to the handle for controlling water flow. The valve is easily operable with the thumb of the same hand which is holding the handle.

FIG. 4 illustrates another embodiment of wand of the invention which includes a pistol grip valve 8 for controlling water flow.

FIG. 5 is a side view of one embodiment of tubular body 15 of the invention in which there are openings along only a portion of the length of the body. Water or other fluid is shown exiting through the openings along approximately one-half of the length of the tube. In FIG. 6, there are openings along virtually the entire length of the tube 16 so that fluid may be dispensed along the full length of the tube.

FIGS. 7 and 8 show two other embodiments of wands 17 and 18 which include curved sections which allow fluid to exit.

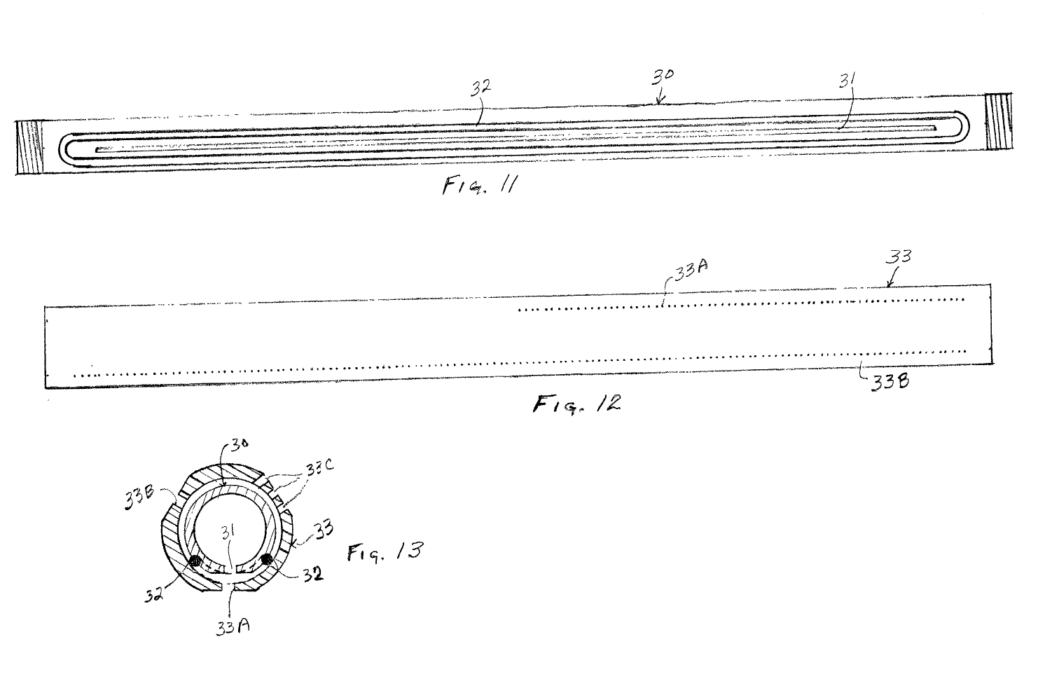

FIG. 9 is a bottom view of one embodiment of a tubular body member in which there is a single row of openings 5A for liquid egress. FIG. 10 is a bottom view of another embodiment of tubular body in which there is a plurality of parallel rows of openings 5B for liquid egress. It is also possible to use a plurality of openings which are not located in parallel rows, if desired. For example, the openings may be staggered and centerlines of discharge openings placed at equal distances of two times the diameter of the discharge openings (for openings having diameters in the range of 0.01 to 0.05 inch). For openings which are larger than 0.05 inch, the spacing between centerlines of the openings may range from 2 to 5 times the opening diameter.

As can be seen in FIG. 1A, it is preferred for one side of the tubular body to include a flat surface, and this is where the openings are located. It is easier to drill the openings through the flat surface, and the flat surface provides more protection for the openings than would be provided by a curved surface. A flat surface is not required, however.

The size of the openings may vary, and they may even vary within the same tube. For example, they may be as small as 0.01 inch and as large as 0.05 inch, or even larger if desired.

The cross-sectional shape of the tubular body may also vary. For example, it may be cylindrical, square, rectangular, triangular, etc.

FIG. 11 shows another embodiment of elongated tube 30 which includes an elongated slot or opening 31 therein. Surrounding the opening 31 is a rubber gasket or seal 32. FIG. 12 shows an elongated sleeve member 33 having a length generally equal to the length of the tube 30 (and an inside diameter slightly larger than the outside diameter of the tube 30).

The sleeve 33 is intended to be placed over the length of the tube 30, whereby the gasket 32 forms a seal between the interior of the sleeve 33 and the exterior of the tube 30 around the opening 31. This is shown in the cross-sectional view of FIG. 13. By rotating the sleeve 33 relative to tube 30, it is possible to access different hole patterns in the sleeve 33. For example, FIG. 12 shows two different hole patterns 33A and 33B which are parallel to each other but spaced apart. FIG. 13 shows that hole pattern 33A in sleeve 33 is aligned with opening 31 in tube 30. Other hole patterns 33B and 33C in sleeve 33 are not exposed to opening 31 unless sleeve 33 is rotated axially relative to tube 30.

The wand of the invention has a variety of purposes. It is especially useful in watering seed beds, plant beds, trays, etc. because it provides a very uniform and gentle distribution of water over the area being treated. The wand also is very useful in other situations where a wide area must be rinsed or washed efficiently (such as hair on pets or horses).

Another advantage of using the water wand is that it is elongated and does not have great thickness or width. It is possible to reach into small areas for watering. For example, in the nursery business when flats of plants are ready to be shipped, they are stacked on shelves in a cart and placed on a loading dock. When the delivery trucks or vendors are late in picking up the plants, the plants may sit for a long period of time and may need to be watered. There currently does not exist any hand-held tool with a watering head small enough to fit between the top of the plants and the bottom of the shelf above them. Using the water wand of this invention, however, enables a person to quickly water all plants in the cart evenly and gently without having to unload the cart before watering.

Other variants are possible without departing from the scope of this invention. For example, this water wand is very useful as a general purpose cleaning tool. The hand-held tool with a pattern of holes in a line offers the user more control of splash and provides for more efficient cleaning. When using a stream sprayer or shower head sprayer, when the emerging water hits a surface, it radiates outwardly, splashing and pushing the debris in all directions. When washing or rinsing soap from a coat of hair (e.g. on a dog), a sprayer that radiates water in all directions takes longer to remove soap and debris because much of it is just chased around at the base of the coat of hair. On the other hand, use of a water curtain from the water wand greatly reduces the amount of time needed to wash because there are only two edges to the curtain of water. The ability to actually sweep debris like a broom with a curtain of water greatly reduces the amount of time required to clean. The water wand is especially useful for washing pets. Most small animal washing stations consist of at least a two-sided area that catches splashing water and carries it to a drain. In the case of dogs at a washing station, they will lean against the wall away from the groomer. This makes it difficult to thoroughly clean the far side of the dog without constantly pulling on the collar or attaching the lead to the opposite side of the tub. Because the watering curtain is discharged from the side of the tube, and the tube is narrow, the tube can easily be placed between the dog and the far wall to sweep out soap and debris quickly and with the same precision achieved on the near side of the animal.

What is claimed is:

1. A hand-held, portable dispensing device for dispensing liquids in a curtain spray pattern, the device comprising an elongated tubular body having an open end and a closed end; wherein said open end is adapted to be connected to a flexible hose for supplying pressurized liquid to said tubular body; wherein said tubular body includes a plurality of openings spaced therealong on one side of said tubular body enabling egress of said liquid; wherein the ratio of the total area of said openings to the interior cross-sectional area of said tubular body is in the range of 0.03 to 5.

2. A hand-held, portable dispensing device in accordance with claim 1, wherein said openings have a diameter in the range of 0.01 to 0.05 inch.

3. A hand-held, portable dispensing device in accordance with claim 2, wherein the centerlines of said openings are spaced twice as far apart as the diameter of said openings.

4. A hand-held, portable dispensing device in accordance with claim 1, wherein the inside diameter of said tubular body is in the range of about 0.25 to 1.5 inches.

5. A hand-held, portable dispensing device in accordance with claim 1, wherein said openings are aligned in a straight line.

6. A hand-held, portable dispensing device in accordance with claim 1, wherein said openings are arranged in parallel rows.

7. A hand-held, portable dispensing device in accordance with claim 1, wherein said openings are staggered.

8. A hand-held, portable dispensing device in accordance with claim 1, wherein said tubular body includes a flat exterior surface, and said openings are located in said flat exterior surface.

9. A hand-held, portable dispensing device in accordance with claim 1, further comprising an adjustable valve connected to said handle and said tubular body for controlling flow of liquid through said tubular body.

10. A hand-held, portable dispensing device in accordance with claim 1, wherein said tubular body is straight.

11. A hand-held, portable dispensing device in accordance with claim 1, wherein said tubular body includes a curved section.

12. A hand-held, portable dispensing device in accordance with claim 9, further comprising a quick coupler means between said valve and said tubular body.

13. A hand-held, portable dispensing device in accordance with claim 1, wherein said closed end comprises a cap member detachably secured to said tubular body.

14. A hand-held, portable dispensing device for dispensing a curtain of liquid, the device comprising:
(a) a first elongated tubular body having an open end which is adapted to be connected to a flexible hose for supplying pressurized liquid to said tubular body, said first tubular body further comprising an elongated slotted opening along one side of said body enabling egress of said liquid; and
(b) a second elongated tubular body having an internal diameter larger than the outside diameter of said first tubular body; wherein said second tubular body includes a plurality of first openings spaced therealong for enabling egress of pressurized liquid; wherein said second tubular body is coaxial with and encloses said first tubular body.

15. A device in accordance with claim 14, wherein said second tubular body further includes a plurality of second openings spaced along said body for enabling egress of pressurized liquid; wherein said second openings are separated from said first openings by seal means positioned around said slotted opening and between said first and second tubular bodies; and wherein said second tubular body is axially movable relative to said first tubular body.
